(19) United States
(12) Patent Application Publication
(10) Pub. No.: US 2025/0232389 A1
(43) Pub. Date: Jul. 17, 2025

(54) Retail Electric Plan And System For End Use Electricity Customers To Increase The Amount Of Renewable Energy They Consume

(71) Applicant: Christopher John Dunbar, Houston, TX (US)

(72) Inventor: Christopher John Dunbar, Houston, TX (US)

(73) Assignee: BreakSmart LLC, Houston, TX (US)

(21) Appl. No.: 18/518,531

(22) PCT Filed: May 23, 2022
(86) PCT No.: PCT/US2022/030518

§ 371 Date: Nov. 23, 2023

Related U.S. Application Data
(60) Provisional application No. 63/192,673, filed on May 25, 2021.

(51) Int. Cl. G06Q 50/06; G06Q 30/0207; G06Q 30/04

(52) U.S. Cl. CPC G06Q 50/06; G06Q 30/0207; G06Q 30/04

(57) ABSTRACT

The present invention provides a system and method for an electricity utility or retail electric provider to incentivize a retail electricity customer to increase the amount of renewable energy they consume through an innovative pricing plan and digital application by letting customers understand how much renewable energy is on the electric grid at any point in time. They receive incentives for using more renewable energy and may also compete against each other or a benchmark customer to have the greenest energy consumption.

### RELATED APPLICATIONS

This application claims the benefit of U.S. Provisional Application No. 63/192,673, May 25, 2021 and PCT Application No. PCT/US22/30518, May 23, 2022.

### FIELD OF INVENTION

The invention presented herewith provides a system and method for an electricity utility or retail electric provider to incentivize a retail electricity customer to increase the amount of renewable energy they consume through an innovative pricing plan and digital application by letting customers understand how much renewable energy is on the electric grid at any point in time. They receive incentives for using more renewable energy and may also compete against each other or a benchmark customer to have the greenest energy consumption.

### BACKGROUND

In recent years energy grids across the world have been going through a massive transition in how electricity is generated. In the past nearly all electricity was generated through thermal generators such as coal and natural gas. As the demand for electricity increases these generators are able to increase or decrease their output, to ensure a reliable electricity grid, with demand and supply always in balance. However, in recent years there has been a push to install ever increasing amounts of clean green renewable energy onto the grid as generation from wind and solar has become much cheaper over time. Although such renewable generation sources bring huge benefits in terms of being pollution free, it now means that a significant portion of the generation on the electric grid is now uncontrollable and there is no guarantee that supply will be produced when people demand it. If we look at data for the ERCOT (Electricity Reliability Council Of Texas) market in Texas where there is the largest build out of wind generation in the US and an ever increasing solar build out, between January to March 2021 the percentage of generation coming from renewable sources varied widely between 1% (600 MW) of the total generation 15^{th} February 2021 at 7 pm and 66% (21185 MW) just after 12 am 22^{nd} March 2021. On average over the period renewable generation on the ERCOT system made up 30% of the total generation.

When renewable energy generators are not producing, then thermal generators such as gas and coal must fill the gap. When this occurs the percentage of power being delivered from dirty carbon producing sources such as coal and gas will increase significantly. Taking the example above at 7 pm on 15^{th} February 2021 90% (39189 MW) of power came from coal and gas, but at 12 am on 22^{nd} March 2021 only 22% (7228 MW) of power came from dirty sources. If consumers want to be “green” in their energy usage, they should therefore be trying to use more power when there is more renewable energy on the grid and less when renewable output to the grid is lower.

Utilities and Retail Electric Providers (REPs) heavily market renewable energy to customers and sell “100% green” products to their customers. In a market such as Texas (ERCOT) these products are very popular. However, these products are mis-leading. As described above the ERCOT system currently only gets to about 66% of power coming from renewable “green” generating resources at a maximum and on average 20-30% of power comes from renewable resources, with current levels of installed renewable generation. The way electricity transmission and distribution works there is no way to direct the electrons from a specific generator to an individual consumer. At any point in time if two customers who are located next each other, where one customer has bought a 100% green product, and the other has not, the renewable content of the power physically delivered to their meter is exactly the same. The reason such products can be marketed as 100% green is that companies are allowed to buy the green energy at times when it is produced and they do not have to match when customers are using power (i.e. they can buy renewable energy at night and use that to “clean” the power their customers use during the day). The market therefore works on this offset principal. However, most customers would assume that 100% green means 100% of the power delivered to their home is actually coming from renewable sources at all times, but this is simply not the case. Under the offset methodology allowed by market rules, utilities are able to buy renewable energy credits (RECs) from renewable energy producers. For each megawatt hour of energy produced from a renewable generator, state programs award a REC certifying that the power has come from a renewable source. Under rules of such programs utilities and REPs are allowed to claim that their products are 100% green if they buy enough of these RECs to cover the full usage of their customers. It does not matter in these programs if the energy was produced at the exact time the customer uses it. While this clearly supports renewable generators by providing demand for RECs, it does not mean that the electrons delivered to the end use customers location are always coming from renewable energy sources. In fact, the amount of dirty power from coal and gas they are consuming is exactly the same as their neighbour assuming they are consuming power in the same way even if their neighbour has not bought a “100% green” energy plan.

The present invention provides a system and method to inform consumers what percentage of power on the grid is coming from renewable resources in real time. It creates a billing system that rewards customers for using more power when more renewable resources are available, automates their smart devices to maximize their use of green power when it is produced, and provides feedback to them so they know how successful they are in truly making their energy consumption greener in a way that garners competition among customers to be the greenest amongst their peers. A reward system is introduced that reduces the price the customer pays for electricity the greener they make their consumption. Finally in an alternative embodiment, a variable price billing system where the price charged changes for each interval period, sells power to customers where the price charged is lower the more renewable energy is currently being generated on the grid.

### SUMMARY OF INVENTION

The present invention discloses a novel method for selling a truly green energy product to consumers that actively rewards customers for consuming more energy when the percentage of energy on the grid coming from renewable sources is higher. The “base price” a customer pays is similar to a traditional fixed price contract, where the rate the customer pays is the same for all their usage over a contract period. However, under the present system the customer is rewarded either by a reduction in their rate or a cash payment or credit in return for using energy in a greener way, which is reduced from the base price they are charged.

The customer is provided with live real time and forecasted information on grid conditions including the percentage of power coming from renewable resources, and information on the available capacity so they can choose to run devices when system capacity (available generation in excess of current demand) is high and the percentage of renewable generation on the grid is high. The scale is also color coded to warn the end user when the grid has low renewable energy. A recommendation for the end use customer to run devices such as washing machines and dishwashers is also made to either “run now” or “run later”.

Smart devices such as smart thermostats, pool pumps and electric vehicle (EV) chargers are connected to the customer's account and are optimized to run so that the percentage of renewable power the customer uses is maximised. This helps the customer to further increase their use of electricity when more renewable power is on the grid without having to manually make changes to how they use power. Discounts or other incentives may be offered for connecting smart devices to the account.

In one embodiment billing occurs based on the average renewable generation that was on the grid while the customer was consuming power. For example, on average 9,000 MW of renewable power may have been on the grid. That average is looked up on a discount table to work out the amount of discount offered to the customer. In an alternative embodiment instead of weighting by the absolute amount of renewable energy, the percentage of renewable energy on the grid is weighted by customer usage across the billing period. This results in calculating the renewable percentage of the customers consumption. For example, the generation may have been on average 20% green when the customer was consuming power meaning the customer's renewable energy consumption was 20% of their total consumption. Again, this is looked up on a discount table to work out the discount offered to the customer.

In another alternative embodiment, customers are compared to a benchmark, either an “average” customer for their location, or they are ranked amongst a population of customers, or both. When the percentage of energy the customer consumes from renewable sources is higher than the average customer or the population of customers, they receive increasing discounts on the rate they pay for being greener consumers of energy depending on how much they beat the benchmark by, either through rate reductions or other incentives including bill credits.

Customers are kept up to date on how green their energy consumption is through use of smart meter usage data as soon as it is available and comparing it to the average customer or the customers “rank” in a population of customers.

In a final embodiment a variable pricing billing method is introduced whereby the rate the customer pays changes for each interval period based on how much renewable energy is on the grid, this may be measured in absolute renewable energy production or renewable generation as a percentage of total generation. The higher the renewable generation or percentage of generation on the grid the lower the price will be to the customer. This could be implemented using distinct levels of renewable generation giving discrete levels of pricing or as a continuously changing price based on an algorithm.

### BRIEF DESCRIPTION OF THE DRAWINGS

FIG. 1 shows the distribution of the percentage of generation that is generated from renewable sources for each 15 minute settlement point period in the ERCOT market between January and March 2021.

FIG. 2 shows a scatter plot of wholesale energy price against the percentage of generation that is generated from renewable sources for each 15 minute settlement point period at the North Hub location in the ERCOT market between January and March 2021.

FIG. 3 shows the display of the customer's bill including the average renewable content of the energy the customer used, and the discount received in cents/kWh to the base rate for the renewable ratio they achieved.

FIG. 4 shows the display of the customer's bill including the average renewable content of the energy the customer used, and the discount received expressed as a percentage to the base rate.

FIG. 5 shows the discount table displayed to the customer where the discount in cents/kWh increases as the renewable concentration of the customer's usage increases.

FIG. 6 shows the discount table displayed to the customer where the discount as a percentage of the base rate increases as the renewable ratio of the customer's usage increases.

FIG. 7 shows the display of the customer's bill when the customer is compared to an average customer or customer profile to determine the discount they receive.

FIG. 8 shows a chart of the percentage of generation that is renewable for each interval period between January and March 2021.

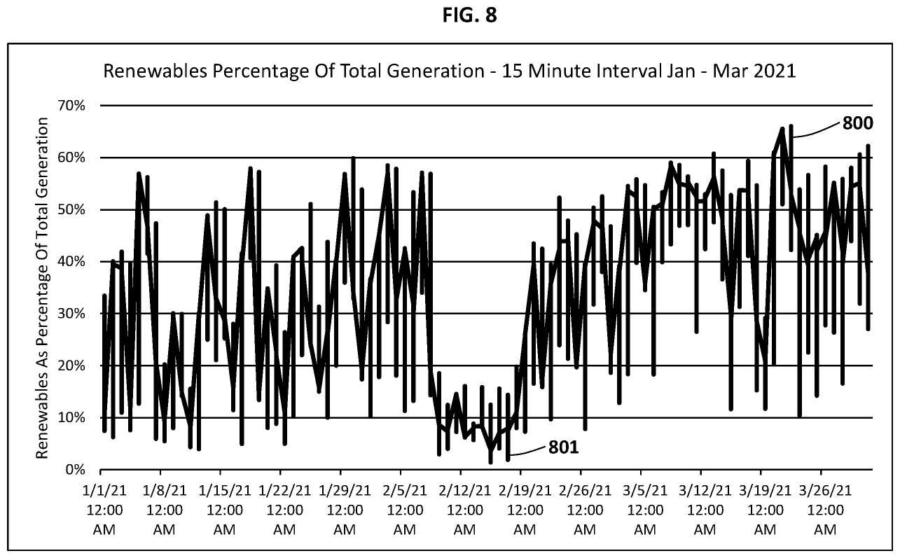

FIG. 9 shows a chart of how the renewable percentage of generation varies across a sample day along with the usage of a customer profile and an actual customer's usage based on smart meter data.

FIG. 10 shows the discount table displayed to the customer where the discount is based on how the renewable content of the customer's usage compares to the renewable content of an average customer profile.

FIG. 11 shows how electricity is distributed to customers and how the renewable energy content of their power is dependent on which generation resources are putting power onto the electric grid.

FIG. 12 shows the display shown to the customer, so the customer can track the renewable content of power available on the grid in real time, and the display also provides recommendations to the customer as to when to run high power consuming devices.

FIG. 13 shows the display shown to the customer so they can track the renewable content of their usage over different time periods and compares their renewable content to an average customer profile.

FIG. 14 shows the discount table shown to the customer where the discount received is based on the renewable content of their usage in a ranking compared to a population of customers.

FIG. 15 shows the price table shown to the customer where the price paid is based on the amount of renewable generation of the power grid during that interval period.

FIG. 16 shows the screen shown to the customer to setup parameters to optimize a smart thermostat to maximize usage when more renewable energy is available on electric grid.

FIG. 17 shows a chart of renewable generation, system load, and the percentage of generation coming from renewable sources for a sample day May 12, 2021.

FIG. 18 shows a how an algorithm optimizes a smart thermostat running profile to maximize usage when more renewable energy is produced on the electric grid.

FIG. 19 shows the screen shown to a customer to setup parameters to optimize a single speed pool pump to maximize usage when more renewable energy is produced on the electric grid.

FIG. 20 shows the screen shown to a customer to setup parameters to optimize a variable speed pool pump to maximize usage when more renewable energy is produced on the electric grid.

FIG. 21 shows a how an algorithm optimizes the running profile of single speed and variable speed pool pumps to maximize usage when more renewable energy is produced on the electric grid.

FIG. 22 shows the screen shown to a customer to setup parameters to optimize an electric vehicle (EV) charger to maximize usage when more renewable energy is produced on the electric grid.

FIG. 23 shows the price table shown to the customer where the price paid is based on the percentage of renewable generation of the power grid during that interval period.

### DETAILED DESCRIPTION OF THE PREFERRED EMBODIMENT

The present invention is a system and method to allow end use customers of electricity to buy power so that the price they pay is reduced from a base price depending on how “green” (using more energy when more renewable energy is on the grid) they make their usage. Two pricing mechanisms are disclosed. Firstly, a fixed price system that offers discounts starting from a base price, where the discount increases depending on how green on average a customer's energy usage is. In the simplest embodiment the consumer is rewarded based on the average renewable content of their energy consumption. In a more complex alternative embodiment, the customer has their usage compared to a benchmark such as an average customer, or to a population of customers. In addition, a variable pricing system is disclosed that varies the price paid by the customer based on the renewable content of the grid, where the greater the percentage of electricity coming from renewable sources the lower the price the customer pays will be. The system provides the information the customer requires to track how green their usage is. The system also integrates customers smart devices and optimizes their running patterns to help make the customers usage patterns as green as possible.

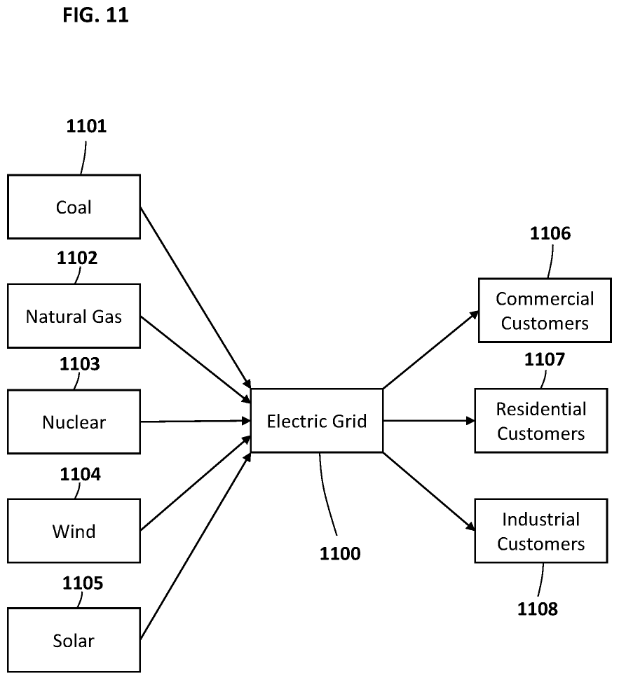

A summary of how electricity is generated and delivered to customers from generators through the electric grid is shown in FIG. 11. At any point in time generating resources compete to provide power onto the grid. The ISO (Independent System Operator) coordinates these generating resource to match supply to demand from customers on the grid. Electricity is unique in the commodity space as at all instances in time supply and demand must be in balance. There are different types of generators using different technologies to generate the power that is put onto the grid. In the past the majority of power came from coal 1101 and natural gas 1102 generators which to a certain extent are able to adjust their output to the ever changing demand from customers (and are often referred to as controllable resources). Nuclear power plants 1103 provide baseload power running all hours of the day. Finally, you have solar 1104 and wind 1105 that make up the main sources of renewable power. They produce power without producing any emissions and are considered “green” generating resources. Solar and wind generation are also uncontrollable resources, with wind generation produced when the wind blows and solar producing generation when the sun shines. As the marginal cost of wind and solar is lower than gas and coal generators they will tend to displace coal and gas generators when they generate and the percentage of power coming from “green” renewable generating sources will increase. Once generated power flows through the electric grid 1100 consisting of the transmission system and distribution system and then on to end use customers consisting of commercial customers 1106, residential customers 1107, and industrial customers 1108. As all the generated power has to be channelled through the electric grid, then on average customers can expect to receive the same mix of electrons in proportion to the amount put into the grid by each generation resource. Therefore if 30% of generation is coming from renewable sources (in our example we could define renewable sources as solar and wind) then each customer can expect the electrons they consume to be 30% from renewable generating resources, and their consumption is 30% “green”. It should be noted we could also include nuclear as a renewable resource. However as nuclear generation tends not to vary and generally produces the same output every hour of the day, and is not “uncontrollable” like solar and wind output there is little to optimize, which is why only solar and wind resources are considered. We will call the percentage of generation coming from renewable energy generators the “renewable power percentage”. If a customer wants to make a decision to be “green” they can therefore increase their consumption when there is a lot of renewable energy, and the renewable power percentage is high. For example, the customer could run their dishwashers and washing machines when more renewable generation is on the grid and reduce their consumption when there is little renewable energy on the grid (the renewable power percentage is low) for example, by increasing the temperature on their thermostat to reduce air conditioner use in their home.

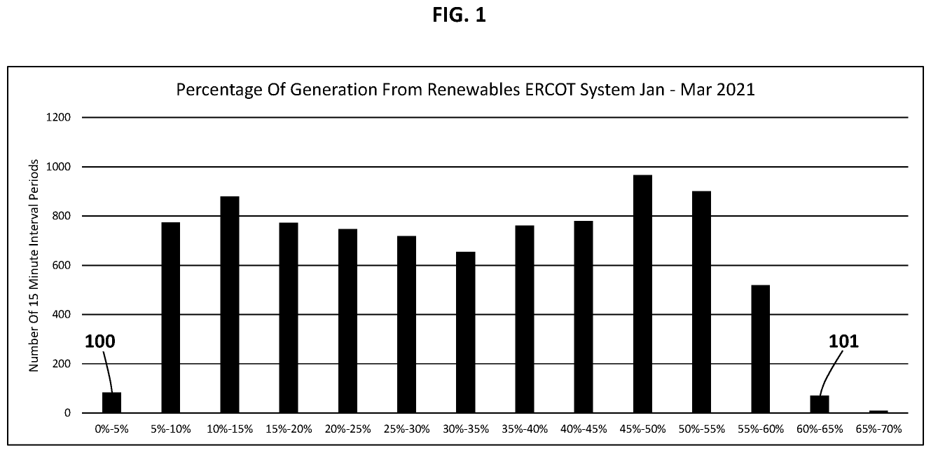

FIG. 1 shows the distribution of the renewable power percentage (percentage of power coming from variable renewable solar and wind sources) for the period January through March 2021 for the ERCOT market in Texas. The chart shows that the amount of green power varies between about 5% (100) and 65% (101) of the total generation being put on the grid. Within this range the chart shows there are similar numbers of hours at each level of renewable power percentage. There is therefore an opportunity for customers to shift their usage from hours with lower levels of renewable generation, to those with higher levels of renewable generation, so they are truly using electricity that has been produced from renewable sources.

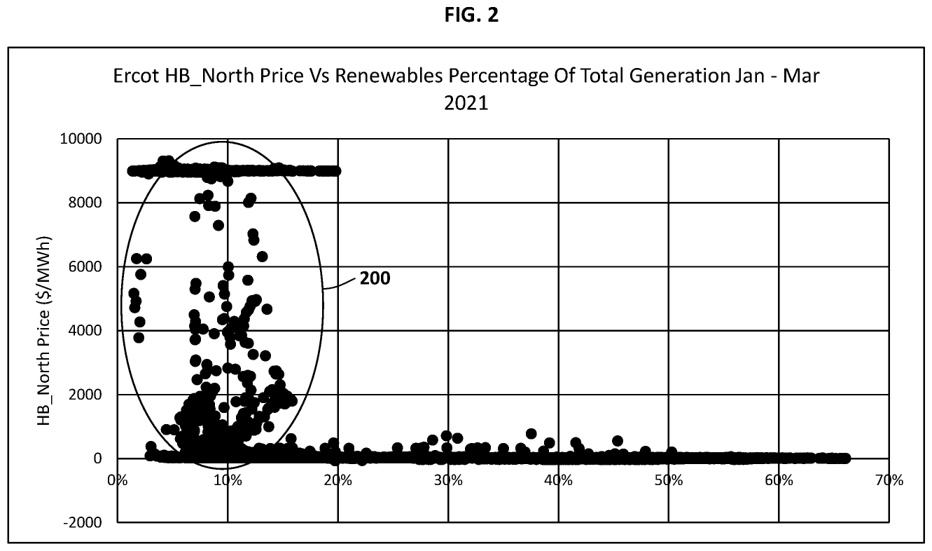

FIG. 2 shows the relation between wholesale electricity pricing (using the real time settlement point price-RTSPP) for the ERCOT North Hub between January and March 2021 and the percentage of generation from renewable generating resources. As you can see from the chart shown by area 200 all the high pricing in the marketplace occurs only when the percentage of generation coming from renewable sources is relatively low. In fact, when renewable generation is above 20% of total generation there are no hours where prices are extreme. This tell us that if end use customers reduce their usage when the renewable power percentage is low, and increases it when renewable generation is high, then as well as the benefit of being greener in their energy consumption, the customer is also reducing the cost for the utility to serve them as a customer as the wholesale cost to purchase power will be reduced since they are avoiding the highest cost hours through shifting their usage to times that generation is greener. These cost savings enable the utility to offer discounts to customers and increase those discounts the greener the customer is able to make their consumption.

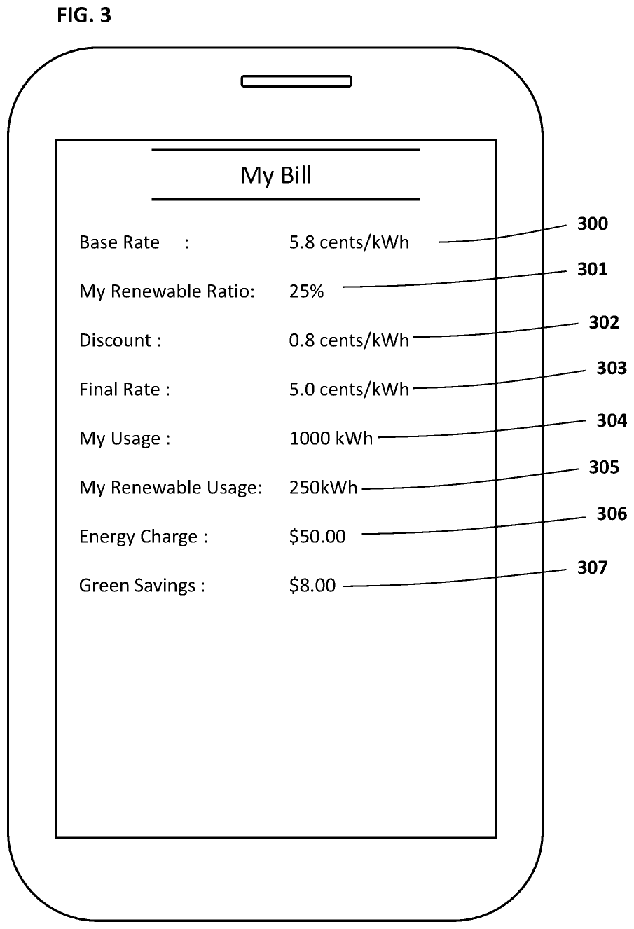

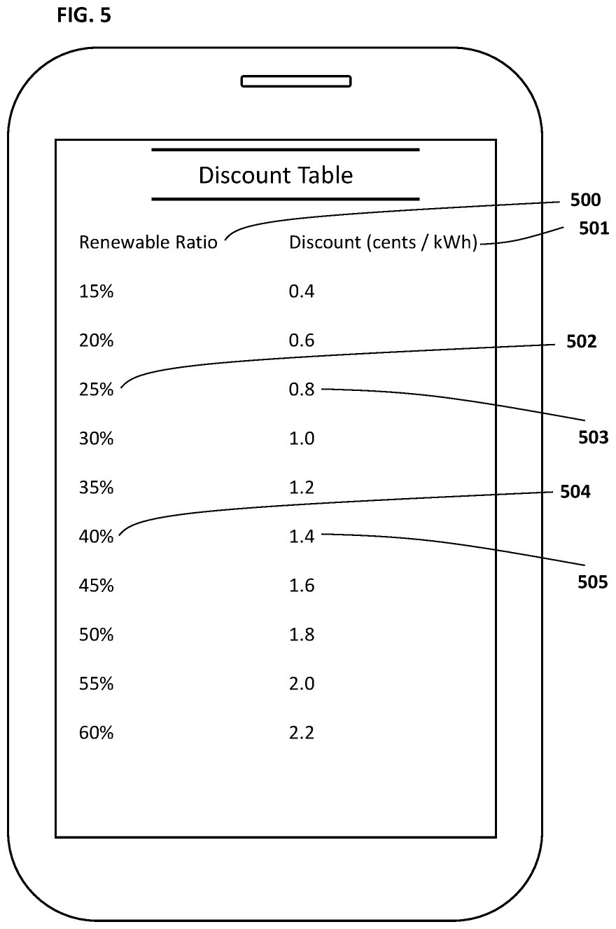

In most regions around the world electricity customers are accustomed to paying a single fixed price for the power they consume. Often this fixed price is sold under a contract where the price paid is fixed for a given period. In competitive retail markets this contract term is usually anywhere from 3 months to 3 years depending on the customer's preference. As customers are accustomed to paying for power in this way it is beneficial to introduce a new product that fits into this same framework of “fixed” prices. FIG. 3 illustrates an example bill a customer would receive that offers a fixed price which is then discounted based on how green a customer's energy consumption is. A contract is sold at a “base rate” of 5.8 cents/kWh (kilowatt hour) 300 just as with the traditional fixed price contract described above. This is in effect the maximum rate the end use customer could end up paying if they do not qualify for any “green” discounts. The customer is then given discounts based on their usage weighted by the renewable power percentage. In this example the customer managed to use energy in a way so that on average during the billing period 25% of their power came from renewable sources 301, the “Renewable Ratio”. To calculate the renewable power percentage of their usage, the customer's smart meter data is taken at the interval measurement level. In the Texas (ERCOT) market each interval period is 15 minutes long. In some markets this might be 30 minutes or longer depending on the market setup. It should be noted it would be possible to implement the system at an interval period that does not match the ISOs interval period. As an example, in ERCOT an alternative interval period of one hour could be used where the total for four 15 minute interval periods in used to perform the calculations disclosed instead. Changing the interval length used in no way changes the principals of the system. The total system demand for the same interval period is then taken, for example it might be 20,000 MWh (megawatt hours). The total power supply coming from renewable sources is also taken for the same interval period, for example it might be 5,000 MWh. For that interval period the “renewable concentration” of power would be 5,000 MWh divided by 20,000 MWh, which is 25%, the renewable power percentage. For all interval periods in the billing period (for example a calendar month) the customer's usage is weighted by the renewable power percentage. That value is then divided by the total usage for the billing period to calculate the weighted average renewable power percentage of consumption show as “My Renewable Ratio” 301. The end use customer is also provided a table of discounts as part of their contract as shown in FIG. 5 where the different levels of discount 501 are shown for each level of renewable ratio 500 achieved. As an example, if a renewable ratio of 25% is achieved 502 then this results in a discount to the base rate of 0.8 cents/kWh 503. If a higher renewable percentage of 40% 504 is achieved, then the discount to the base rate increases to 1.4 cents/kWh 505. If we assume that the renewable ratio for a customer is 25% as shown in 301, then using the Discount Table shown in FIG. 5 a 25% weighted average renewable ratio 502 leads to a 0.8 cents/kWh discount as shown in 302 and 503. The base rate 300 of 5.8 cents/kWh minus the discount of 0.8 cents/kWh 302 leads to a final rate 303 of 5.0 cents/kWh. The customers total usage for the billing period is 1000 kWh 304. Given that the average renewable generation online when the end use customer was using electricity was 25%, we can say that total usage 304 (1000 kWh) multiplied by the Renewal Ratio of 25% 301 tells us that the customer used 250 kWh of renewable power shown in 305. The total cost of the customer's energy 306 is the final rate 303 multiplied by the customer's usage 304. The cost savings the customer received for the renewable concentration of their energy consumption 307 is discount rate 302 multiplied by the total usage 304.

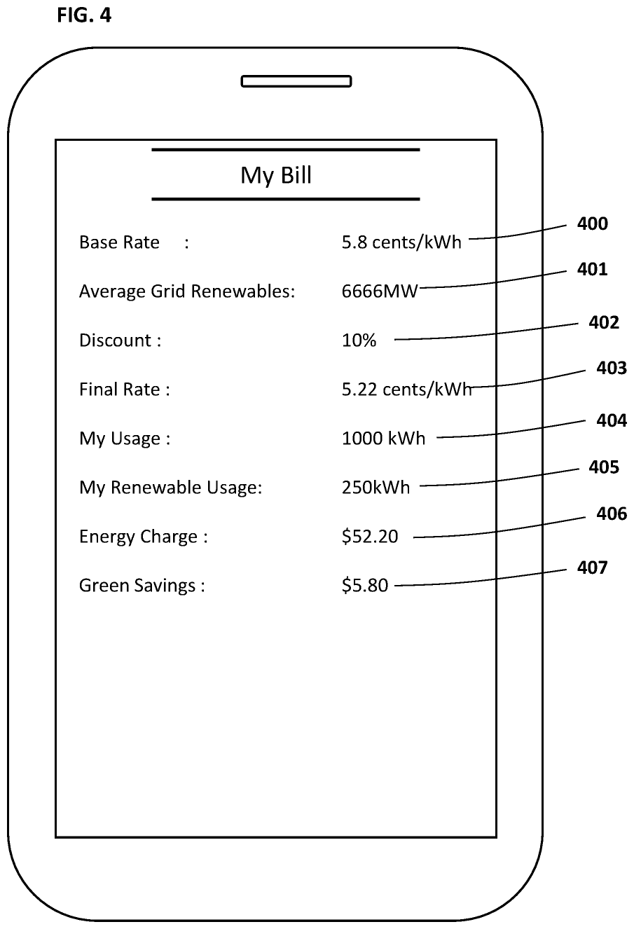

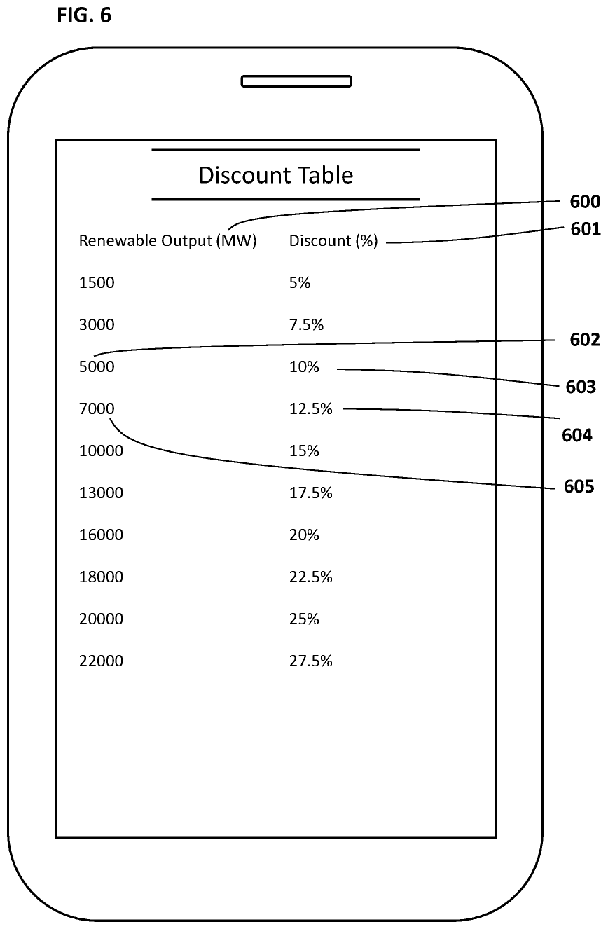

An alternative discount table is shown in FIG. 6 where the discount is based on the average total renewable energy that is available on the grid at the time the customer uses their power. For example, if during two interval periods the customer used 5 kWh when the grid produced 10,000 MWh from renewable resources, and 10 kWh when the grid produced 5,000 MWh from renewable resources, then the weighted average total usage is (5 kWh multiplied by 10,000 MWh) plus (10 kWh multiplied by 5,000 MWh) all divided by the total MWh of grid renewable generation (5,000 MWh plus 5,000 MWh equals 10,000 MWh). This results in a weighted average grid renewable production of 6,666 MW. In the discount table shown in FIG. 6 a list of renewable output levels 600 is shown along with a discount expressed as a percentage 601. This is the average grid renewable energy supplied weighted by the customers usage for each interval in a billing period. This is an alternative measure of how green power is on the grid at any point in time compared to the average generation output from renewable sources expressed as a percentage of total generation (the renewable ratio) shown in FIG. 5. In the example above the weighted average renewable output is 6,666 MW, looking this value up on the table, the usage is greater than 5,000 MW 602 but less than 7,000 MW 605 so the discount achieved would be at the 5000 MW 602 level which gives a 10% discount 603. This bill is represented in FIG. 4. Assuming the base rate is once again 5.8 cents/kWh as shown in 400. The average grid renewable output is 6666 MW 401 and using the table in FIG. 6 this results in a discount of 10% 402, this results in a final rate of 5.22 cents/kWh 403. The total usage is again assumed to be 1000 kWh for the billing period 404. Multiplying the 1000 kWh of usage 404 by the final rate of 5.22 cents/kWh 403 leads to an energy charge of $52.20 406. The customer has achieved a saving of $5.80 407 based on using power with an average renewable level on the grid of 6666 MW. 405 shows the amount of renewable generation used by the customer.

In summary a method is disclosed whereby a customer is charged a base price for their electricity usage which is then discounted based on how green they can make their energy consumption by consuming more power when more renewable energy is available on the grid. The measure of renewable energy could be either the percentage of renewable energy on the grid compared to total supply (or demand as supply must equal demand at all times on the electric system) as disclosed in FIG. 3, or the absolute level of renewable energy on the grid as disclosed in FIG. 4. The customer is then given a discount that increases the more they use power when more renewable energy is available on the grid. The discount may be expressed as a percentage of the base rate as disclosed in FIG. 3 or as an absolute discount expressed in cents/kWh as shown in FIG. 4. In addition, the discount could take other forms such as gift cards, cash discounts, bill credits and other incentives that are typical in the retail electric and utility space. All methods discussed thus far also use a discount table to look up the discount offered. Instead of a lookup table it would be possible to use a formula to define the discount. For example, in FIG. 5 instead of looking up a discount in cents/kWh, you could have a simple formula such as discount=0.5*Renewable Ratio. This would mean that for a renewable ratio of 50%, the customer would receive 0.5*50%=25% discount. Each method disclosed could also take a similar formulaic approach.

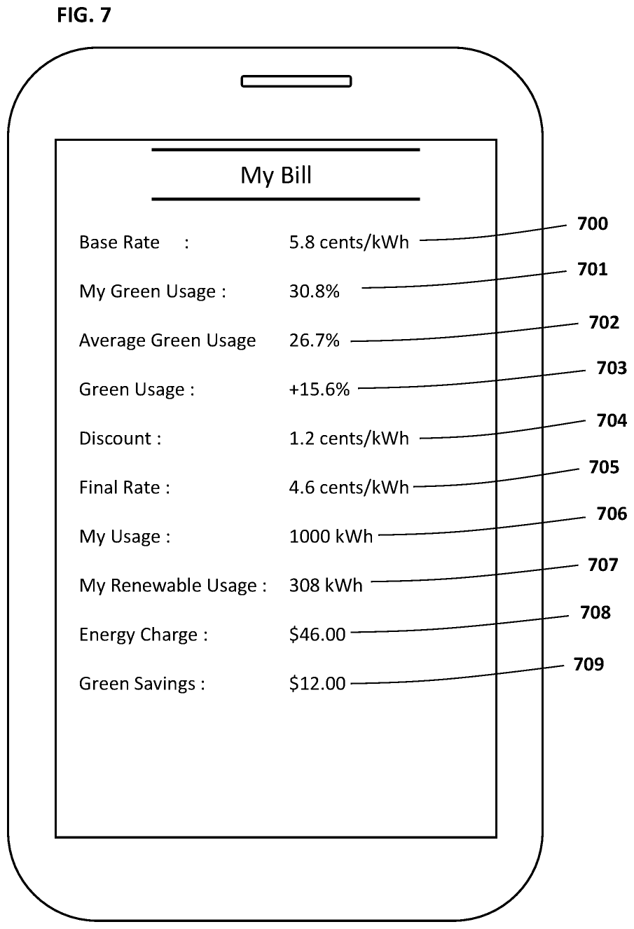

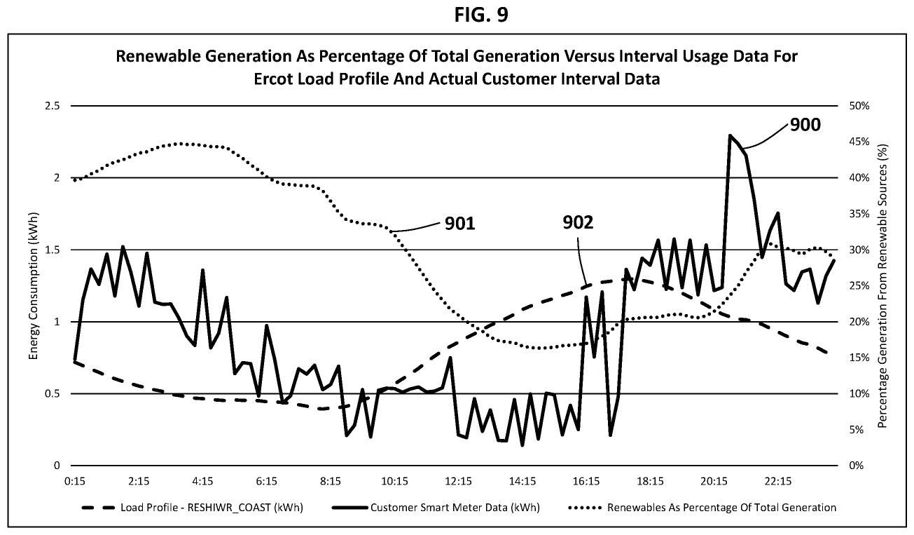

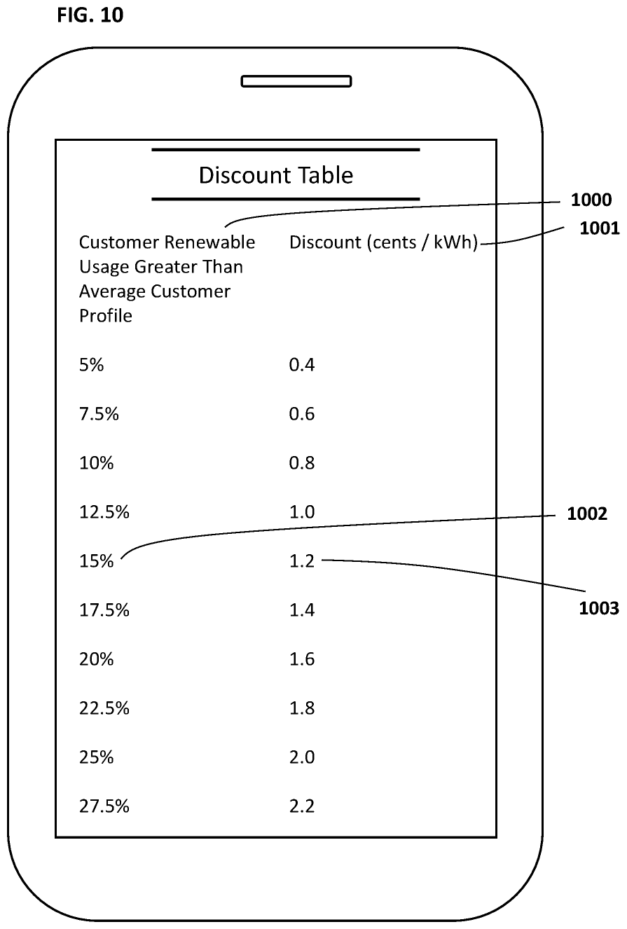

In an alternative embodiment a benchmark is introduced where customers are incentivized to make their usage “greener” than the benchmark by using more energy when more renewable energy is on the grid. The benchmark used may vary, but the idea of the mechanism will be the same. If the customer “beats” the benchmark by using more renewable power by increasing their consumption when more renewable power is on the grid compared to the benchmark, then they will be rewarded for doing so. One such benchmark could be an “average” customers usage. In most ISO (Independent System Operator) areas the ISO will determine what the “average customer usage” looks like for each customer type. These usage patterns are often referred to as load profiles. In the Texas market, ERCOT publishes these load profiles in public data sets. FIG. 9 illustrates how this benchmark calculation is made. The chart shows the interval level data for a sample day (14^{th} August 2020). Firstly 900 is interval (15 minute) usage data from Smart Meter Texas for an actual customer in the coastal region of ERCOT that has been assigned to the RESLOWR_COAST load profile by ERCOT. 902 shows the usage of an “average” customer using the published settled load profile for a RESLOWR_COAST load profile type. As you can see the usage profile of the actual customer 900 is very different from the “average” customer profile 902. The actual customer 900 uses more power in the early hours of the day and late hours of the day whereas the average customer profile 902 shows that most customers use less power in the overnight hours and more in the middle of the day. 901 shows the percentage of generation coming from renewable generating resources on the right axis. As you can see a greater percentage of renewable energy 901 is on the grid in the early hours of the day, less in the middle of the day and then more again the late evening hours. In general, from the chart it can be seen that the usage of the actual customer 900 better matches the profile of renewable energy being put on the grid 901, compared to the average customer 902. If you weight the average grid renewable percentage 901 by the usage for both the actual customer 900 and the average customer profile 902, the average renewable generation percentage for the actual customer 900 is 30.8% renewable versus 26.7% renewable for the average customer profile 902. We can therefore say that on this sample day the actual customer's usage was 15.6% greener than the average customer. It would be possible to have a similar discount table as disclosed in FIG. 5 and FIG. 6 to provide discounts to the customer. This new discount table is shown in FIG. 10. The table shows the percentage of renewable energy the customer was able to use more than the benchmark customer profile 1000 and the associated discount that is offered to the customer 1001. In our example in FIG. 9 we calculated that the actual customer used 15.6% more renewable power than the average customer profile. Looking this value up on the table in FIG. 10 we see that the discount offered is for greater than 15% 1002 and gives the customer a 1.2 cent/kWh discount 1003. As previously disclosed the discount given may be expressed as a percentage discount to a base rate, offered as a gift card, or some other incentive scheme that is common in the industry. FIG. 7 illustrates how the discount could be given for using more renewable energy than the benchmark customer profile. This takes the 15.6% discount shown in the data from FIG. 10 and assumes that the customer was able to match the same 15.6% greater renewable usage for the single day across the entire billing period.

Another alternative discount mechanism would be to make the discount proportional to the percentage that the customer is using more renewable energy compared to the benchmark customer profile. For example, the discount could me made equal to the percentage that the customer is using more renewable energy than the average customer. In our example the customer used 15.6% more renewable power than the average customer, so the discount would also be 15.6% of the base rate of 5.8 cents/kWh which is 4.9 cents/kWh.

FIG. 7 shows how the bill would be broken down for the customer where the discount offered is related to an average customer profile. This example is consistent with the example discount table shown in FIG. 10. The customer has a base rate of 5.8 cents/kWh 700 and managed to use power so 30.8% 701 of their power came from renewable sources. During the same period the average customer profile was only 26.7% renewable 702 meaning that the customer used 15.6% 703 more renewable power than the average customer. Using the discount table in FIG. 10 this results in a 1.2 cents/kWh discount 704 and a final rate the customer pays of 4.6 cents/kWh 705. Assuming the customers total usage is 1000 kWh 706 this means that 308 kWh 707 of their usage came from renewable sources. The total energy cost for the billing period is $46 708 and the savings made by the customer for using more renewable energy than the average customer profile is $12 709.

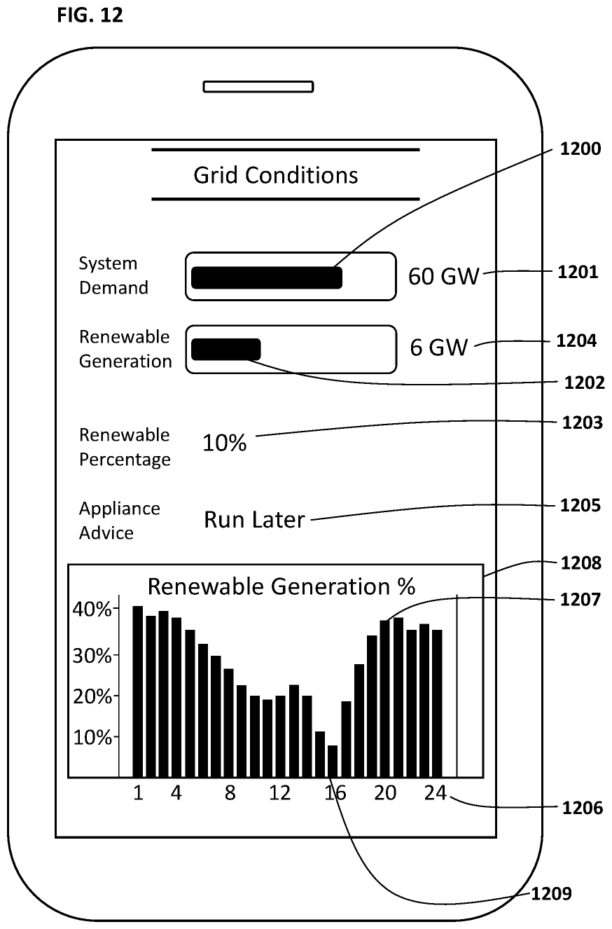

FIG. 12 shows how information about the renewable energy on the grid could be relayed to the customer in real time through a web or mobile digital application. A “power bar” 1200 shows the current demand on the electric grid, where the length of the bar shows how much current demand there is relative to the maximum potential system demand. Higher demand all else equal reduces the percentage of generation coming from renewable sources, so as demand increases the color of the bar will change, green at low demand levels, orange at medium demand levels, and red at high demand levels. This “traffic light system” will help to make it obvious to consumers when demand is high and that they should try to reduce their usage. In the example total system demand is 60 GW (gigawatts) shown by 1201. The amount of renewable energy currently generating is shown on a separate “power bar” 1202 and is at the 6 GW level 1204. In the example renewable generation is relatively low with the power bar 1204 relatively low compared to the renewable generation total capacity. With demand on the system of 60 GW 1201 and renewable generation of 6 GW 1204 this means that currently 10% of power is coming from renewable sources 1203. As well as real time information on renewable generation, a forecast of renewable generation and renewable generation as a percentage of total generation could be provided. 1208 provides a forecast of expected renewable percentage of generation for each hour of the day (hour 1 through 24) as shown by 1206. If the current level is 10% 1203 it is likely we are at hour 16 (3 μm to 4 pm) 1209. This is when the renewable generation is at its lowest point. The consumer is incentivized to reduce their usage at this time, as the forecast shows that the renewable generation percentage is forecast to increase to just below 40% by hour 20 (7 pm to 8 pm) 1207. The system therefore presents the message to the customer advising them how to run their devices (for example washing machines and dishwashers) to “Run Later” 1206. If we happened to be at a time when renewable generation was high for example if the time was hour 20 1207 then the appliance advice would change to “Run Now”.

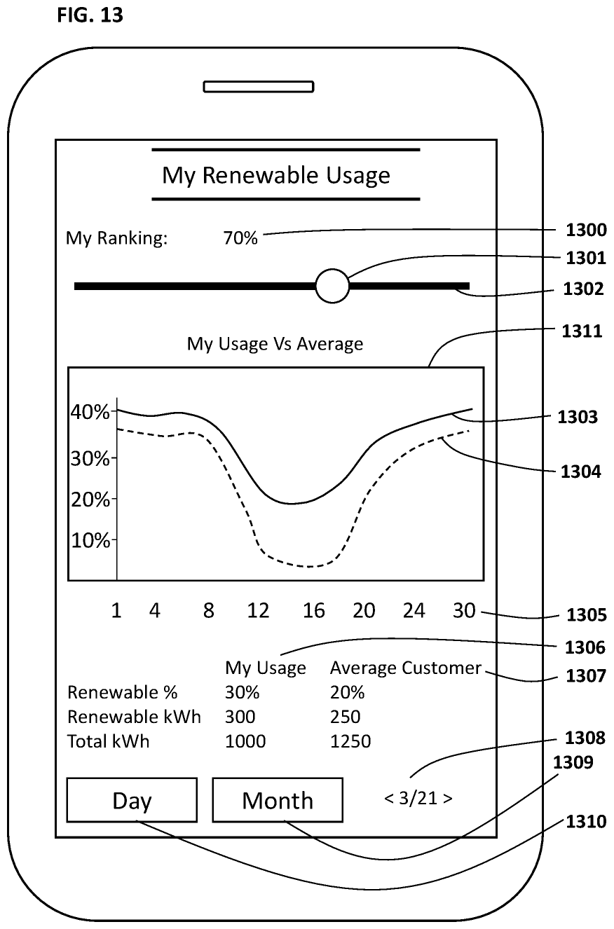

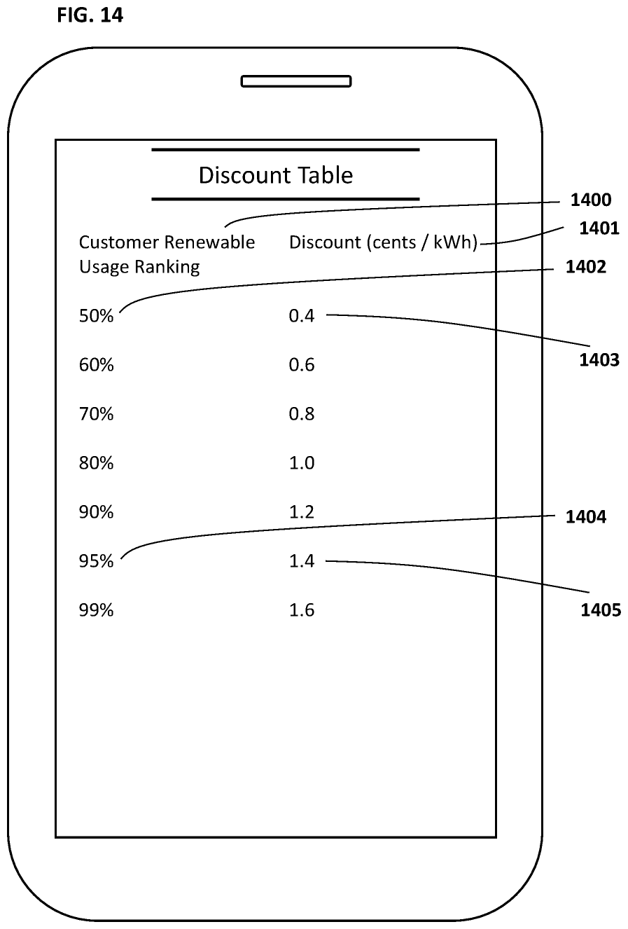

FIG. 13 shows how a customer's renewable energy usage could be tracked. A customer could be compared to a population of customers and ranked in order of the renewable power percentage they were able to achieve for the selected period. 1300 shows this customer was ranked in the 70^{th} percentile, meaning that they were greener than 70% of all customers, but less green than 30% of all customers in their energy usage. 1301 shows their position on a slider bar 1302. If the customer was in the 1^{st} percentile, then the position circle 1301 would be all the way over to the left. If they were in the 99^{th} percentile then the position circle 1301 would be all the way to the right. In another alternative embodiment, instead of providing discounts to a base rate using either the absolute level of renewables on the grid or the customers renewable power percentage, the discount could be based on where the customer ranks in terms of their renewable power percentage compared to a population of customers. FIG. 14 shows how this would work. A table of the customer renewable usage ranking 1400, which represents how many more customers an individual customer has a greater renewable power percentage than, and a discount 1401 on the rate the customer pays. For example, if the customer renewable power percentage ranking 1400 was 99%, then that would mean the individual customer is using more renewable energy than 99% of customers. In the example no incentive is provided for those who are below the 50^{th} percentile (i.e. those in the lower 50% of customers will receive no discount. For customers between the 50^{th} and 60^{th} percentile 1402 a discount of 0.4 cents/kWh 1403 is awarded. If the customer is in the 95^{th} to 99^{th} percentile 1404 then they receive a discount of 1.4 cents/kWh 1405. As well as showing the customers ranking in FIG. 13 it is also possible to show the customer how they compare to the average customer profile. 1311 shows a chart of the average renewable power percentage for each day in a month 1305 for the customers usage 1303 the solid line and for the average customer profile 1304 the dashed line. As you can see this customer 1303 has been successful in making the renewable power percentage of their consumption higher than the average customer profile renewable power percentage for each day of the month. The renewable power percentage falls between the 12^{th} and 18^{th} days in the month on the chart for both the average customer profile and the customer themselves. This likely means that there was simply less renewable energy on the grid during this time, so the renewable concentration fell for both. The chart provides the information to the customer to let them know how they are doing in trying to use more renewable energy. It would be possible to add further information to the chart. For example, the renewable power percentage for the 75^{th} percentile customer could be added to provide a more “challenging” benchmark to beat. Below the chart the customers renewable usage information (My Usage) 1306 is shown along side the average customer profile information 1307. As you can see in this example the customer used more renewable energy than the average customer profile 300 kWh versus the 250 kWh of renewable energy the average customer profile uses even though their total usage 1000 kWh is less than the 1250 kWh that the average customer profile uses. As shown, the digital application is showing information averaged at the monthly level. The data could be shown at either the monthly or daily level simply by tapping the button for Day 1310 or for month 1309. The current date or month is changed using a date selector with arrows to move to the next month or next day 1308.

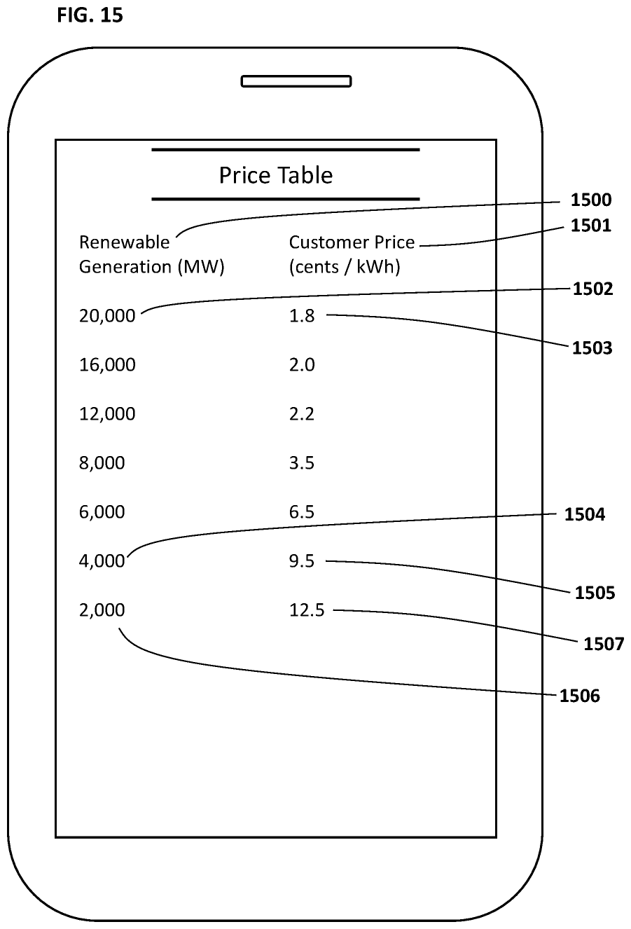

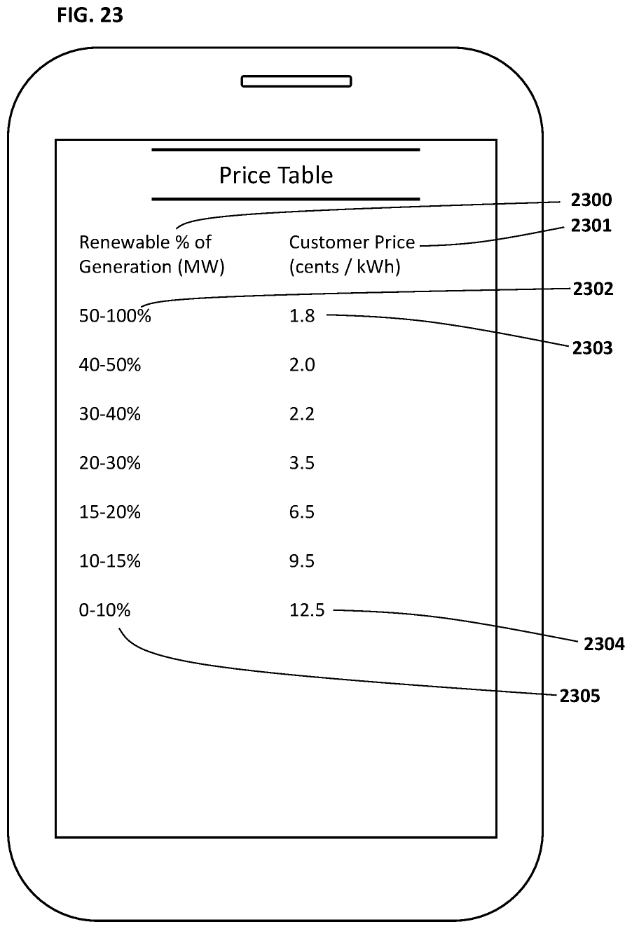

In each embodiment disclosed so far, we have started with a fixed price that is charged to the customer which is then discounted in a variety of ways (all of which increase the discount given based on the customer using more power when more renewable energy is available on the grid). In another alternative embodiment, the price charged to the customer may vary in each interval period based on the amount of renewable energy on the grid. The customer in this case will be presented with a variable price that changes for each interval period. Their total cost of consumption for a billing period in this case will be the interval price multiplied by their interval usage summed for all interval periods in the billing period. In one implementation the price charged could be looked up on a table. This is shown in FIG. 15 in the price table. The table shows the price charged 1501 for each level of renewable generation available on the grid. The higher the level of renewable generation, the lower the price charged to the customer giving the customer an incentive to try and shift their usage into periods where renewable generation is higher. If the amount of renewable generation on the grid is above 20,000 MW 1502 then the price will be the lowest possible at 1.8 cents/kWh 1503. If the amount of renewable generation is low between 4,000 MW and 6,000 MW 1504 then the price charged will be 9.5 cents/kWh. In this example the maximum price will be when renewable generation is below 2000 MW 1506 where the price is 12.5 cents/kWh 1507. In a very similar embodiment instead of the price being determined by the absolute level of renewable energy generation, the price could be determined by the percentage of generation coming from renewable resources as shown in FIG. 23. FIG. 23 shows a price lookup table where each level of renewable percentage of generation 2300 is associated with a different price 2301. If the renewable percentage of generation is high between 50-100% as shown in 2302 this results in the lowest discrete price level possible of 1.8 cents/kWh 2303. As the renewable percentage of generation falls the price charged increases until the renewable energy percentage falls into the lowest band of 0-10% 2304 where the highest price 12.5 cents/kWh 2305 is charged.

The price charged may also be determined by an algorithm that uses the amount of renewable energy on the grid to reduce the price charged. As an example, a simple linear formula could be used where the price charged is proportional to the renewable generation on the grid. The formula could be as simple as price=15−(0.00085*renewable generation). There may also be a minimum price below which the formula does not apply, and the minimum price is used instead. Let's assume a minimum price of 1.8 cents/kWh. The price is calculated for each interval (usually 15 minutes) based on the renewable generation that occurs during that time period on the system. In our example we input this in terms of the average MW produced during the period. Usually, the renewable generation for an interval period is reported in MWh, so if in the interval there are 2,500 MWh of renewable generation produced, and the interval period is 15 minutes long, then the average MW produce is 2,500*4 (as there are four 15 minute periods in an hour) which is 10,000 MW. The price with an average of 10,000 MW would then be price=15−(0.00085*10,000), which is 6.5 cents/kWh. If the average renewable MW were lower at 1,000 MW for the interval period, then the price would be, price=15−(0.00085*1,000), which is 14.15 cents/kWh. A higher price gives the customer an incentive to use less power when renewable generation is lower. If renewable generation is high at 20,000 MW then the calculated price is 15−(0.00085*20,000), which is-2 cents/kWh, however we have a minimum price of 1.8 cents/kWh so in this case the customer will be charged 1.8 cents/kWh as the calculated price is lower than the minimum price. This provides an example of a simple formulaic implementation of pricing based on grid renewable output. Clearly there are almost limitless formulas that could be used which would result in the desired result of charging customers less when more renewable generation is on the grid to encourage green energy use.

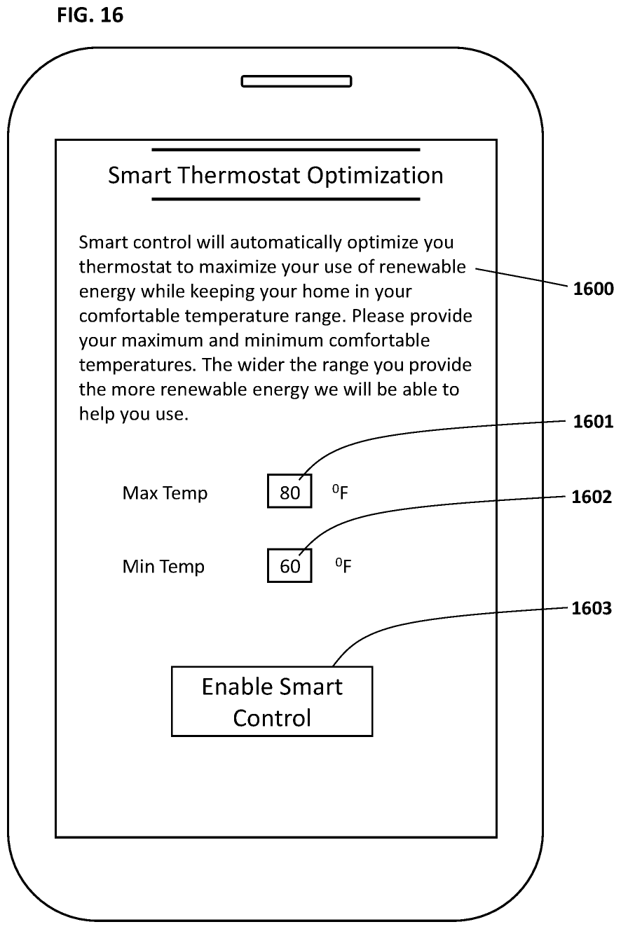

The disclosed systems and methods provide billing mechanisms to encourage customers to use more energy when there is more renewable energy on the grid. A digital application is disclosed that will show the amount of renewable energy on the grid in real time and the forecast amount of renewable energy on the grid in the future as shown in FIG. 12 and the users can take actions directly in usage of their devices to use more power, for example running a dishwasher or washing machine when more renewable energy is available. However, it is burdensome to the consumer to have to watch the renewable content of electricity continuously and have to make manual adjustments to their appliances. It is preferable for consumers to have their devices automatically react to the changing renewable energy conditions on the grid. FIG. 16 discloses a screen shown to a customer to enable such an optimization algorithm for a smart thermostat. The design keeps the parameters simple, so it is easy for the customer to understand. A text instruction set 1600 explains that, the system is able to optimize their smart thermostat to use more renewable energy while still keeping the customer comfortable. The only parameters the system needs from the customer is their comfortable temperature range. The system asks the customer to input a maximum temperature 1601 and a minimum temperature 1602 they are comfortable with. The algorithm will ensure any changes it makes to the customers thermostat will respect the maximum and minimum temperatures set.

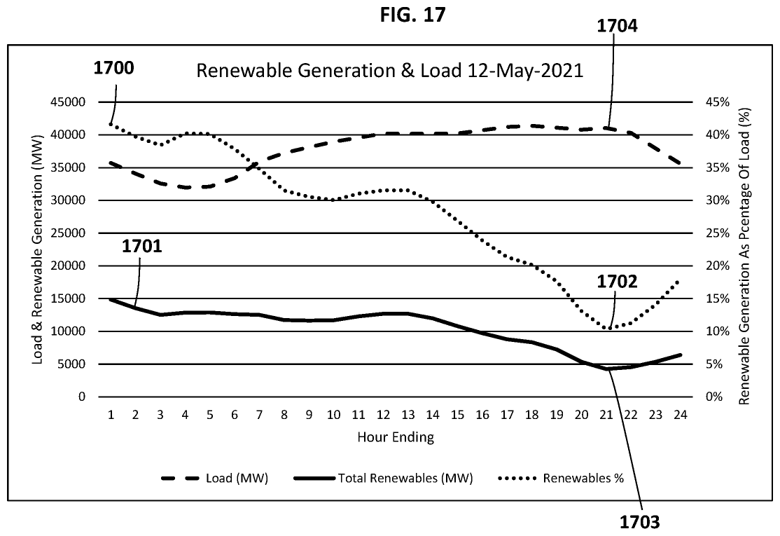

FIG. 17 shows an illustrative day on the ERCOT system where there is an opportunity to optimize a customers electricity usage for cooling, so they use more renewable power when it is available. The system load 1704 is shown on the left axis, and it shows a typical summer shape increasing in the middle of the day to just over 40,000 MW and reducing in the evening hours. The system load bottoms out around 32,000 MW in the early morning hours. On the same left axis, the total renewable generation is also shown. In the early hours, the generation from renewables is high 1701 starting out around 15,000 MW at the beginning of the day. Renewable generation then generally falls across the day bottoming out around hour ending 21 as shown in 1703 just below 5000 MW. This highlights how much renewable generation can move across a day, with only a third of the output at the end of the day compared to the beginning of the day. The percentage of generation that is renewable is calculated by dividing the total renewable output 1701 by the total system load 1704. The percentage of generation that is renewable is shown by the dotted line, against the right hand axis. As you can see the percentage of generation that is renewable peaks at the beginning of the day at just over 40% 1700. However, over the course of the day as renewable generation falls off the percentage of generation coming from renewable sources falls bottoming out at hour ending 21 as show by 1702 at just above 10%. Clearly if a customer is able to concentrate their electricity usage in the early hours of the day then the amount of renewable power the customer is using will be much higher.

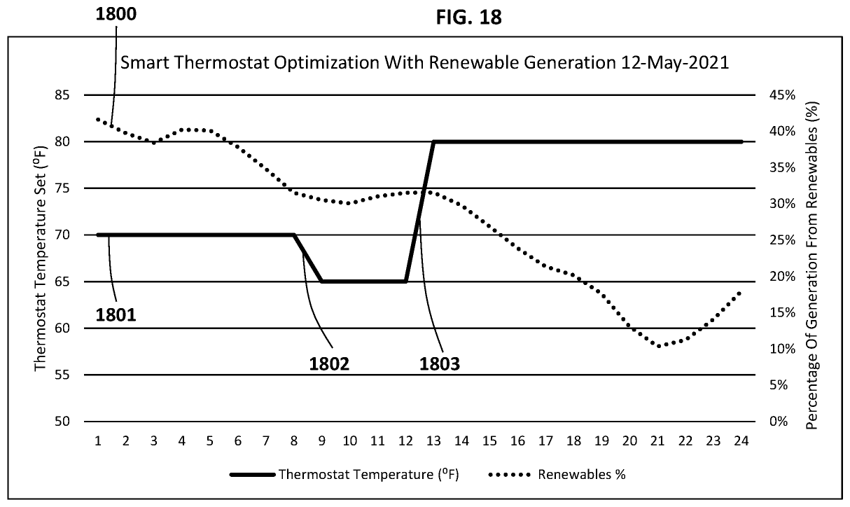

FIG. 18 shows the same operating day as in FIG. 17 along with the percentage of generation that is renewable 1800 on the right-hand axis. The thick black line shows how an optimization algorithm may maximise usage when the renewable percentage of generation is higher. The algorithm is set to respect the customers comfortable temperature range as shown in FIG. 16 with a high of 80° F. 1601 and a low of 60° F. 1602. In the early hours, the customer has set the temperature at 70° F. 1801. As the renewable percentage of generation is relatively high there is no need for the algorithm to make any adjustments. However, at hour ending 8 the algorithm steps in to reduce the thermostat setting to 65° F. 1802. This causes the AC system to run harder use more power and cool the house. The algorithm makes this decision because it sees that the renewable percentage is expected to fall off during the day as shown by the dotted line 1800. This additional cooling between hour ending 9 and hour end 12 then means that less cooling will be needed in the later hours where the amount of renewable energy on the grid is much lower. As the renewable percentage drops at hour ending 12 the algorithm increases the thermostat setting to 80° F. 1803. This minimizes the amount of energy needed for cooling while staying within the comfortable range given by the customer, so that minimal energy is used during the hour ending 13 to 24 when the renewable percentage of generation is higher.

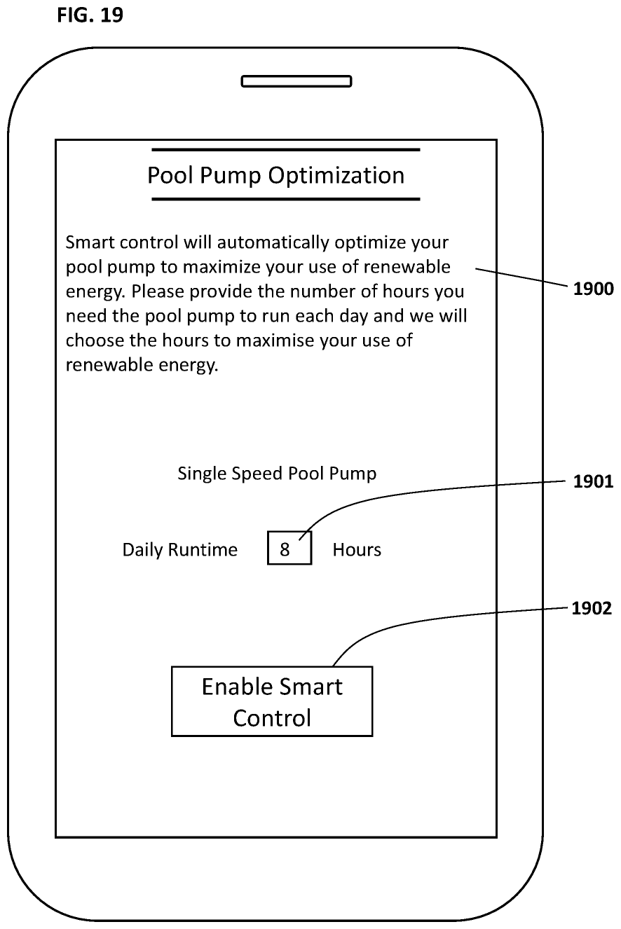

FIG. 19 and FIG. 20 and FIG. 21 show how an optimization algorithm may maximize the renewable energy usage of pool pumps. A pool pump is a piece of equipment that is common in many homes and it has a lot of flexibility in when it runs. Most people will run their equipment for at least 8 hours per day, and generally they will need to run longer in the summer. However, the exact hours they run is generally not important which makes them ideal to optimize to run when there is the most renewable energy on the grid. There are two types of pool pump, single speed and variable speed. For single speed, the pump runs at the same (single) speed when it is on while with a variable speed pump the speed (and energy usage) can be adjusted. Variable speed pumps can be more energy efficient by running for more hours at a lower speed, but will likely be required to be run at least some hours at a higher speed for example when the pool cleaner is also running or a salt chlorine generator is active in the case of a saltwater pool.

For a single speed pool pump FIG. 19, shows how a customer can provide the running hour parameters need for the optimization algorithm to run the pool pump. The digital application provides text 1900 informing the customer they are about to allow the system to determine how the pool pump runs. The customer enters the number of hours that they want the pool pump to run each day 1901 before pushing the button 1902 to enable the system to begin controlling the pool pump.

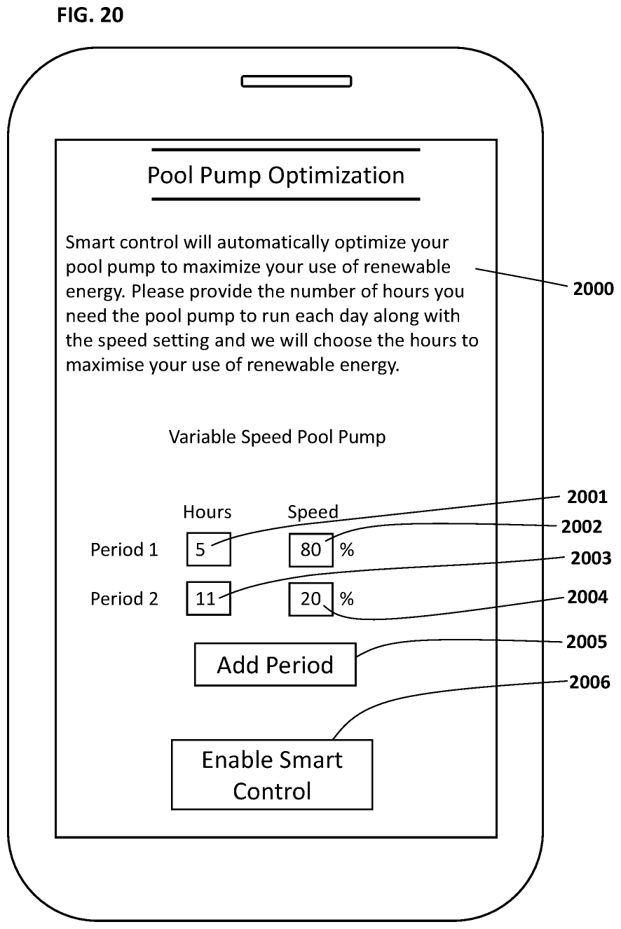

For a variable speed pool pump the process is very similar as shown in FIG. 20 where the customer provides parameters of what speed to run the pump at and the number of hours to do so. In the example the first period is set to run at a speed of 80% 2002 of the maximum speed. Alternative units of speed could be used. For example, the customer could also be asked to enter the spin speed in revolutions per minute (rpm). Along with the speed, the number of hours is also entered which in the example is 5 hours 2001 for the first period. The customer in this case has also entered a second period where the pool pump will run at a low speed of 20% 2004 for a longer period of 11 hours 2003. If the customer wants to add further periods they can do so with the “Add Period” button 2005. The customer then presses the “Enable Smart Control” button 2006 to enable the smart control of their pool pump.

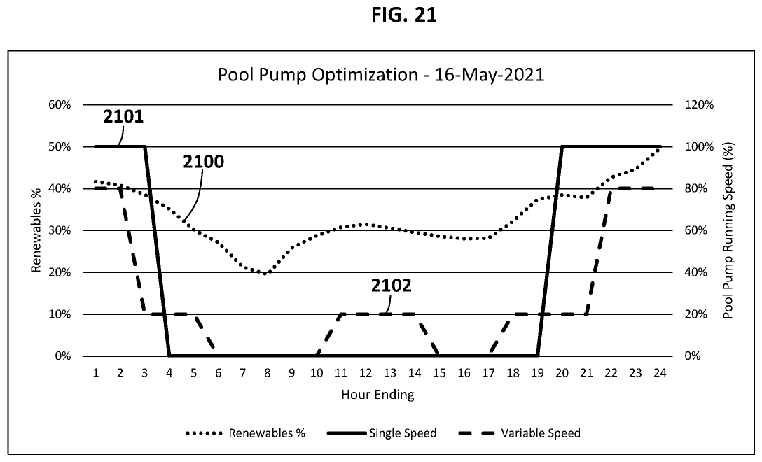

FIG. 21 takes an example day of May 16, 2021 and shows how an optimization algorithm maximizes renewable energy use for pool pumps using information on the expected percentage of generation coming from renewable sources. 2100 the dotted line shows on the left axis the percentage of generation coming from renewables. As you can see in the early hours renewable generation is high over 40%, but then bottoms out around hour ending 8 (as wind production reduces) before increasing to hour ending 12 (as solar power increases) before an early evening slight drop off (as solar power reduces) before again increasing rapidly as wind generation increases into the later evening hours. 2101 shows the optimized running profile for the single speed pool pump. As there is only one speed, the pump is either on (at 100% output as shown on the right axis) or off at 0% output. From FIG. 19 we can see that the customer set the pool pump to run for 8 hours 1901. The algorithm sees the forecast that renewable generation is expected to be highest in the early hours (hour ending 1 through 3) and the late hours (hour ending 20 through 24), and it therefore chooses to run the pump during these hours to maximize the amount of renewable energy used by the pool pump. 2102 shows the running profile for the variable speed pool pump. From FIG. 20 we can see that the customer has entered two schedules that the pool pump must run. It needs to run at 80% speed 2002 for 5 hours 2001 and at 20% speed 2004 for 11 hours 2003. The algorithm will try to run the highest speed period in the hours with the most renewable energy to maximize the renewable energy usage of the device. In this example the 5 highest renewable energy hours are hour ending 1 through2 and hour ending 22 through 25, so this is when the pool pump will run on its higher setting of 80% speed. The algorithm then chooses the next 11 hours with the highest renewable percentage of generation on the grid. These are the hours next to the 80% level (hour ending 3 through 5 and hour ending 18 through 21) along with hours in the middle of the day (where solar output picks up) hour ending 11 through 14. The algorithm by ranking hours in order of expected renewable generation is therefore able to maximize the renewable generation used by the device.

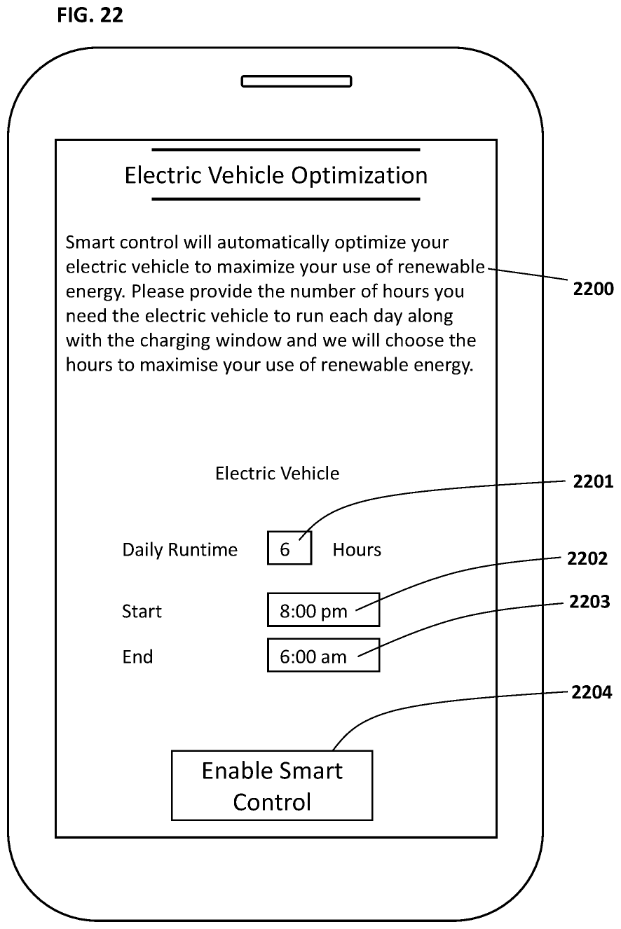

Such optimizations to maximize the use of renewable energy can also be used on other devices in a very similar way. For example, an electric vehicle (EV) charger would work in a similar way to a single speed pool pump. However, with an EV charger there may be further parameters required. For example, a user will generally want an EV to charge overnight and be ready to use in the morning. FIG. 22 shows a user interface to setup optimization for EV charging. A text section 2200 explains how EV charging will be automatically optimized for the EV. The number of hours required for charging is set 2201. In an alternative embodiment instead of setting charging hours, the system may set the battery level required, for example 100% (the battery is fully charged). The algorithm will then work out the number of hours required to charge the battery. The customer then selects the start time 2202 and end time 2203 for the charging. The algorithm will then optimize the charging profile in the same way as for the pool pumps and smart thermostat ranking hours based on their expected renewable content and charges the EV to maximize the renewable energy consumed. The customer presses the enable smart control button 2204 to initiate the optimization of EV charging.

To encourage the adoption of smart control, the utility could also provide further pricing incentives simply for customers connecting their devices to optimization services. This could be a cash discount per month, for example a flat $5/month reduction on the customer's bill. It could also take the form or additional discounts to the customer's rate. For example, in FIG. 3 an additional rate discount could be added of 0.2 cents/kWh, which would take the total discount to 1.0 cents/kWh meaning the final rate 303 would be reduced to 4.8 cents/kWh. It is likely as more devices are added the discount received would need to be reduced, and there may be a maximum total device discount that is available irrespective of how many devices the customer connects to the system.

What is claimed is:

1. A retail electric billing methodology whereby the level of renewable generation for an electric grid is monitored and recorded along with interval level customer usage information for each settlement period within a billing cycle; a customer is charged a base rate for their consumption which is then discounted the more they are able to use power when more renewable generation is being generated on the electric grid.

2. The discount of claim 1 being offered is expressed as a percentage of the base price, or as a rate discount in cents/kWh terms or equivalent units.

3. The discount of claim 1 is based on the absolute MW output of renewable generation producing on the electric grid, or based on the percentage of generation coming from renewable sources.

4. The discount of claim 1 is based on a comparison of the customer's renewable power percentage to a benchmark renewable power percentage where said benchmark is either an average customer user profile, or comparison to a population of customers.

5. The discount of claim 1 is based on discrete levels of grid renewable generation output, or the percentage of generation from renewable sources which can be looked up on a discount table to find the discount offered.

6. A retail electric billing methodology whereby the level of renewable generation for an electric grid is monitored and recorded along with interval level customer usage information for each settlement period within a billing cycle; a customer is charged a varying price for each interval or hourly period where the price charged is dependent on the level of renewable generation on the electric grid and the price increases as less renewable generation is available on the electric grid.

7. The price charged in claim 6 is based on discrete levels of grid renewable generation output, or the percentage of generation from renewable sources which can be looked up on a discount table to find the price offered.

8. The price charged in claim 6 is based on either the absolute MW output of renewable generation producing on the electric grid, or based on the percentage of generation coming from renewable sources.

9. Optimization of a smart device whereby an algorithm uses actual and forecasted values for the level of renewable generation on an electric grid; the algorithm controls the smart device to increases energy usage of the smart device when there are higher levels of renewable generation on a grid; the algorithm reduces energy usage of the smart device when lower levels of renewable generation are on the grid.

10. The smart device in claim 9 is a smart thermostat where the customer additionally provides a minimum comfortable temperature and a maximum comfortable temperature input to the optimization algorithm that the algorithm will not exceed while performing its optimization to maximize the renewable power consumption of the device.

11. The smart device in claim 9 is a single speed pool pump where the customer additionally provides a number of hours to run the device in a day as input to the optimization algorithm; the optimization algorithm runs the device for the required period choosing to run in the hours with the highest renewable percentage of generation.

12. The smart device of claim 9 is a variable speed pool pump where the customer additionally provides the number of hours to run and the speed at which to run the pump for a number of distinct periods as input to the optimization algorithm; the optimization algorithm runs the highest speed periods in hours where the renewable percentage of generation is highest.

13. A display that shows a customer's renewable power percentage in graphical form and compares it to a benchmark customer profile.
